(19) United States
(12) Patent Application Publication
(10) Pub. No.: US 2007/0294082 A1
(43) Pub. Date: Dec. 20, 2007

(54) Voice Recognition Method and System Adapted to the Characteristics of Non-Native Speakers

(75) Inventors: Denis Jouvet, Lannion (FR); Katarina Bartkova, Lannion (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/658,010

(22) PCT Filed: Jul. 22, 2004
(86) PCT No.: PCT/FR04/01958

§ 371 Date: Jan. 22, 2007

(51) Int. Cl. G10L 15/00

(52) U.S. Cl. 704/231; 704/E15.001

(57) ABSTRACT

The invention relates to a voice signal recognition method comprising a step of producing an iterative learning procedure of acoustic models representing a standard set of models of voice units pronounced in a given target language and a step of using the acoustic models to recognize the voice signal by comparing said signal with the acoustic models previously obtained. The method consists in further producing an additional set of voice units in the target language adapted to the characteristics of a foreign language during the production of the acoustic models.

The invention relates to the recognition of speech in an audio signal, for example an audio signal uttered by a speaker.

The invention relates more particularly to an automatic voice recognition method and system based on the use of acoustic models of voice signals whereby speech is modeled in the form of one or more successions of models of vocal units each corresponding to one or more phonemes.

A particularly beneficial application of such methods and systems is to the automatic recognition of speech for dictation or in the context of interactive voice services linked to telephony.

Various types of modeling may be used in the context of speech recognition. See for example the paper by Lawrence R. Rabinet entitled “A Tutorial on Hidden Markov Models and Selected Applications in Speech Recognition”, Proceedings of the IEEE, Vol. 77, No. 2, February 1989, which describes the use of hidden Markov models to model voice signals.

In such modeling, a vocal unit, for example a phoneme or a word, is represented in the form of one or more sequences of states and a set of probability densities modeling the spectral shapes that result from an acoustic analysis. The probability densities are associated with the states or the transitions between states. This modeling then recognizes an uttered speech segment by matching available models associated with units (for example phonemes) known to the voice recognition system. The set of available models is obtained beforehand through a learning process, with the aid of a predetermined algorithm.

In other words, all the parameters characterizing the models of the vocal units are determined from identified samples using a learning algorithm.

Moreover, to achieve good recognition performance, the modeling of the phonemes generally takes account of the influence of their context, for example the phonemes that precede and follow the current phoneme.

For a speaker-independent speech recognition system, the acoustic models of the phonemes (or other chosen units) must be estimated from examples of the pronunciation of words or phrases obtained from several thousand speakers. For each unit (phoneme, etc.), this large speech corpus provides numerous examples of the pronunciation thereof by a great variety of speakers, and thus enables the estimation of parameters that characterize a wide range of pronunciations.

For the French language, for example, there are typically around 36 phonemes and the acoustic models of those phonemes are generally estimated from several tens of hours of speech signal corresponding to the pronunciation by French speakers of words or phrases in the French language. The situation is naturally transposed to each language processed by a recognition system: the number and the nature of the phonemes and the speech corpus are specific to each language.

To estimate the acoustic models of the vocal units, each word or phrase from the speech corpus is described in terms of one or more successions of vocal units representing the various possible pronunciations of that word or phrase.

For example, the French pronunciation in terms of phonemes of the word “Paris” may be written:
Paris [symbol] ##.p.a.r.i.$$
   where “##” and “$$” represent models of the silence at the start and end of an utterance, which may be identical, and “.” indicates the succession of units, here of phonemes.

More precisely, the description of the word “Paris” used to estimate the acoustic models in standard modeling of the French language, which is the “target” language here, is written:
Paris [symbol] ##.p_fr_FR.a_fr_FR.r_fr_FR.i_fr_FR.$$
   where “_fr” indicates the target language processed, here the French language, and “_FR” indicates the source of the data used to learn the parameters of the models, here France.

If a plurality of variant pronunciations exist for an utterance, the learning algorithm automatically determines the variant that leads to the best alignment score, i.e. that best matches the pronunciation of the utterance. The algorithm then retains only the statistical information linked to that alignment.

The learning process is iterative. The parameters, which are estimated on each iteration, result from the cumulative statistics over all of the alignments of the learning data.

The approach described above leads to good recognition performance under interference-free conditions of use. In fact, the closer the conditions of use are to the conditions for recording the speech corpus used to learn the models, the better the recognition performance.

In fact, as mentioned above, recognition systems identify words pronounced by comparing the measurements effected on the speech signal with prototypes characterizing the words to be recognized. Because those prototypes are fabricated from examples of pronunciation of words and phrases, they are representative of the pronunciation of those words under the conditions of acquisition of the corpus: types of speaker, surroundings and background noise, type of microphone employed, transmission network used, etc. Consequently, any significant modification of conditions between the acquisition of the corpus and the use of the recognition system degrades recognition performance.

Clearly, changing the type of speaker between the acquisition of the corpus and the use of the recognition system leads to this kind of modification of conditions. In particular, the problem is exacerbated for the recognition of speech as pronounced by speakers having a foreign accent. In fact, non-native speakers may have difficulty in pronouncing sounds that do not exist in their native languages, or sounds may be pronounced slightly differently in the two languages (native and foreign).

In a recognition system used in a standard configuration, the acoustic models are typically learned from data obtained exclusively from native speakers of the language processed, and therefore represent well only the standard pronunciation of the phonemes. Similarly, the description of the words in terms of phonemes takes account only of the native pronunciations of the words.

Consequently, as there are no added variants of pronunciation and the acoustic models do not represent correctly the sounds spoken by non-native speakers of the language concerned, recognition performance is significantly degraded if the speaker has a marked foreign accent.

The paper by K. Bartkova and D. Jouvet, “Language based phoneme model combination for ASR adaptation to foreign accent”, Proceedings ICPHS'99, International Conference on Phonetic Sciences, San Francisco, USA, 1-7 Aug. 1999, vol. 3, pp. 1725-1728, proposes a variant of the standard configuration of a speech recognition system, i.e. one using only models of phonemes pronounced by native speakers. It proposes to enrich the description of the pronunciation by adding variants that use models of phonemes of the native language. In other words, the paper proposes to add models of phonemes in the foreign language concerned, i.e. the language of the non-native speaker, in order to enrich the database of models.

However, this approach has the drawback that it is necessary to decide for each word to be recognized which phoneme models it is beneficial to use in addition to the native pronunciation(s) of that word.

The object of the invention is to alleviate the above-mentioned drawbacks and to provide a speech recognition method and system enabling recognition of words or phrases pronounced by a non-native speaker.

The invention therefore consists in a method of recognizing a voice signal, comprising a step of generation by an iterative learning procedure of acoustic models representing a standard set of models of vocal units uttered in a given target language and a step of using the acoustic models to recognize the voice signal by comparison of that signal with the acoustic models obtained beforehand. According to a general feature of this method, during the generation of the acoustic models, there is further generated an additional set of models of vocal units in the target language adapted to the characteristics of a foreign language.

This method has the advantage of adapting the acoustic models to one or more foreign languages and therefore of reducing the error rate during voice recognition caused by the different pronunciations of non-native speakers.

According to another feature of this method, the additional set of models of vocal units of the target language adapted to the characteristics of a foreign language is estimated from pronunciations of words or phrases in a foreign language.

Thus the additional set of models of vocal units is generated from phonemes, words, or phrases uttered by one or more non-native speakers of the target language.

According to another feature of the invention, a voice signal uttered in a target language and comprising phonemes pronounced in accordance with characteristics of a foreign language is recognized by comparing each utterance with the vocal unit models of the additional set and with the vocal unit models of the standard set.

According to another feature of the invention, a voice signal uttered in a target language and comprising phonemes pronounced in accordance with characteristics of a foreign language is recognized by comparing the signal to be recognized with a combination of vocal unit models of the standard set and vocal unit models of the additional set.

According to another feature of the invention, the acoustic models further comprise a set of models of vocal units uttered in a foreign language.

According to another feature of the invention, a voice signal uttered in a target language and modified in accordance with characteristics of a foreign language is recognized by comparing it with a combination of models of vocal units further comprising a set of models of vocal units uttered in a foreign language.

A voice signal may be compared either to models of vocal units or to combinations of models of vocal units belonging to the standard and additional sets of models or to another set of models of vocal units in a foreign language.

The invention also consists in a voice recognition system comprising means for analyzing voice signals by using an iterative learning procedure to generate acoustic models representing a standard set of models of vocal units uttered in a given target language and means for comparing a voice signal to be recognized with the acoustic models of vocal units obtained beforehand. The acoustic models further comprise an additional set of models of vocal units in the target language adapted to the characteristics of a foreign language.

Other objects, features, and advantages of the invention become apparent on reading the following description, which is given by way of non-limiting example only and with reference to the appended drawings, in which:

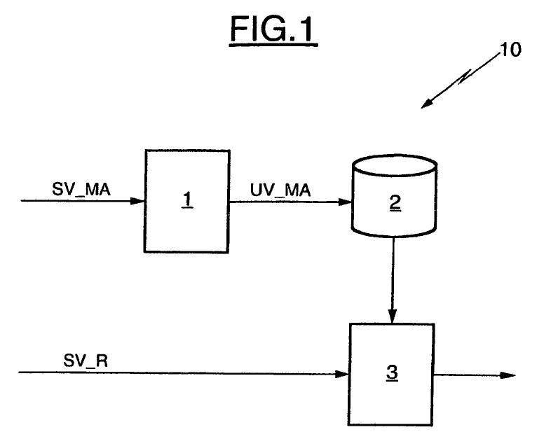

FIG. 1 is a block diagram showing the general structure of a voice recognition system of the invention;

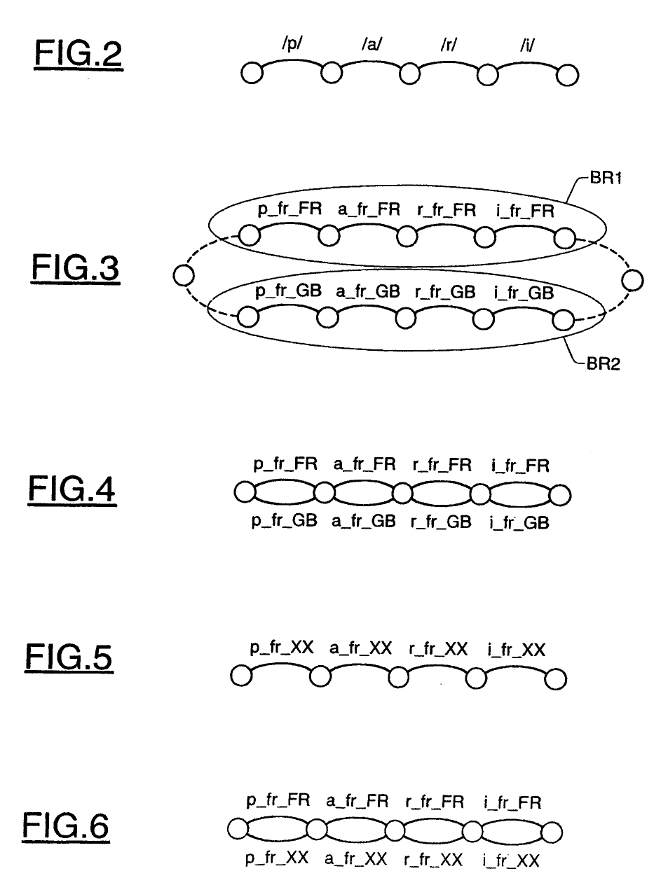

FIG. 2 is a diagrammatic representation of a word divided into phonemes;

FIG. 3 is a block diagram showing the voice recognition method of the invention;

FIG. 4 shows a variant of the voice recognition method of the invention;

FIGS. 5 and 6 represent a variant of the voice recognition method of the invention.

FIG. 1 represents in a highly schematic manner the general structure of a voice recognition system in accordance with the invention and designated by the general reference number 10.

As can be seen, this system receives as input voice signals SV_MA that are used to generate acoustic models and voice signals SV_R that are to be recognized using the acoustic models.

The system 10 includes means 1 for analyzing the voice signals SV_MA adapted to generate acoustic models that are to be used for voice recognition. The analysis means 1 determine from all of the voice signals SV_MA a speech corpus made up of models of vocal units UV_MA, for example phonemes, to form the set of acoustic models 2 that are to be used for voice recognition.

For voice recognition as such, comparison means 3 connected to the set of acoustic models 2 receive as input the voice signal SV_R to be recognized. The comparison means 3 compare the voice signal SV_R to be recognized with the acoustic models 2 previously generated by the analysis means 1. They therefore enable the voice signal SV_R to be recognized on the basis of the acoustic models 2 of the vocal units UV_MA.

Refer now to FIG. 2, which represents diagrammatically, for the purposes of this example, how the word “Paris” is divided into phonemes. The word “Paris” is divided into four phonemes, as described above. The division into vocal units, here into phonemes, is the basis of the step of generating a set of acoustic models and the basis of the step of recognition as such of vocal data.

During the step of generation of acoustic models of vocal units adapted to the characteristics of a foreign language, a match is established between phonemes of the two languages, i.e. between the foreign language under consideration and the target language. Thus the adaptation of the acoustic models of the target language is based on speech data characteristic of the foreign language.

In the following example, matches are effected between phonemes in the English language, which is the foreign language considered in this example, and their equivalent in the French language.

For example, if a_gb denotes the phoneme “a” expressed in the English language and a_fr denotes the phoneme “a” expressed in the French language, the match may be simply expressed as a_gb [symbol] a_fr. However, it may equally be expressed in a more complex manner. For example, with regard to a phoneme “dge”, this match could be expressed by: dge_gb [symbol] d_fr.ge_fr.

Thus the division into vocal units of the English pronunciation of the words “Paris” and “message”:

Paris_gb [symbol] ##.p_gb.a_gb.r_gb.i_gb.s_gb.$$ message_gb [symbol] ##.m_gb.e_gb.s_gb.I_gb.dge_gb.$$ is transformed, by application of these matches, into a division into vocal units of the target language:
Paris_fr_GB [symbol] ##.p_fr_GB.a_fr_GB.r_fr_GB.i_fr_GB.s_fr_GB.$$
message_fr_GB [symbol] ##.m_fr_GB.e_fr_GB.s_fr_GB.i_fr_GB.d_fr_GB.ge_fr_GB.$$

The first suffix_fr indicates the target language of the phonemes concerned, here the French language. The second suffix_GB indicates the foreign language spoken by the speaker.

Processing in this way all of the data uttered in the foreign language and applying a standard learning adaptation procedure yields a set of additional acoustic models of the vocal units of the target language, here the French language, adapted to speech in the language of the non-native speaker, as pronounced by the non-native speaker.

Moreover, so as not to skew the estimation of the parameters, a few phonemes may be considered to have no match, and then the corresponding phrases or words are ignored during the stage of generating acoustic models of the vocal units adapted to the characteristics of a foreign language.

Refer next to FIG. 3, which shows a voice recognition method of the invention. This method takes account of the additional set of phoneme models that consist of the acoustic models of the phonemes of the French language adapted to the characteristics of pronunciation by a non-native speaker, generated as described above.

The voice recognition method according to the invention must then take account of two sets of vocal unit models. Thus for the word “Paris”, the following division applies: 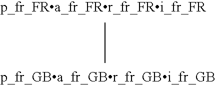
where the symbol “|” designates a choice between the two forms of modeling of the pronunciation.

The first form of modeling of the pronunciation groups together the acoustic models corresponding to the phonemes of the French language as spoken by a French speaker, the French language being the target language in this example. These phoneme models therefore correspond to the standard set of acoustic models of phonemes.

The second form of modeling of the pronunciation groups together the acoustic models corresponding to the phonemes of the French language as uttered by a non-native speaker, an English person in this example. These phoneme models therefore correspond to the additional set of acoustic models of phonemes.

Thus, as shown in the FIG. 3 diagram, during voice recognition of a word based on generated acoustic models, the voice signal to be recognized is compared with acoustic models belonging firstly to the standard set of phoneme models grouped together in the branch BR1, and secondly to the additional set of models of phonemes of the target language, here the English language, in the branch BR2.

When the comparisons have been effected with both of the branches BR1 and BR2, the result associated with the branch giving the higher alignment score is finally retained.

Refer now to FIG. 4, which represents a variant of the voice recognition method of the invention. This variant also uses phoneme models belonging to the standard set of phoneme models and to the additional set of phoneme models. However, during the comparison with the voice signal to be recognized, if the comparison algorithm deems it pertinent, this variant authorizes alternation between the phoneme models of the standard set and the phoneme models of the additional set.

Such variants offer great flexibility during voice recognition. For example, they enable the recognition of a word in which only one phoneme is pronounced with a foreign accent. Another application is the pronunciation of a word of foreign origin, for example a proper noun, in a phrase uttered in the target language, for example in the French language. That word may then be pronounced in the French manner, calling on the phoneme models of the standard set, or with the foreign accent, calling on the phoneme models of the additional set.

Furthermore, the grain of the parallelism may be finer or coarser, going from phoneme to phrase for example. Thus a voice signal may be compared either to models of vocal units or to combinations of models of vocal units.

Moreover, acoustic models may be generated that are adapted not to the characteristics of only one foreign language but to the characteristics of a plurality of foreign languages. Thus the word “Paris” would be divided in the following manner:
Paris_fr_XX [symbol] p_fr_XX.a_fr_XX.r_fr_XX.i_fr_XX

The symbol_XX corresponds to a set of foreign languages. The generation of the acoustic models of the vocal units is then based on an extensive set of multilingual data. The acoustic models obtained then correspond to the pronunciation of these sounds by a wide range of foreign speakers. The learning corpus may equally contain additional speech data as pronounced by native speakers, i.e. data as typically used for learning the acoustic models of the standard set.

The models of phonemes adapted from data for a plurality of foreign languages may be used exclusively, as shown in FIG. 5. A word is then recognized by comparing the voice signal to be recognized with the acoustic models of the additional set.

If the comparison algorithm deems it pertinent, the variant represented in FIG. 6 authorizes alternation, during comparison with the voice signal to be recognized, between the phoneme models of the standard set and the phoneme models of the additional set.

Furthermore, according to another variant of the invention, the set of acoustic models may be further enriched by adding to the standard set models of phonemes of the target language and to the additional set another set of models of phonemes corresponding to the foreign language of the speaker concerned. Thus, during the voice recognition of a word, each utterance may be compared with combinations of models coming from three distinct sets of acoustic models: the standard set of the target language, the additional set of the target language adapted for a non-native speaker, and a set of models for phonemes in the foreign language.

Thus enriching all of the acoustic models with an additional set adapted to the characteristics of a foreign language significantly reduces the recognition error rate.

1. A method of recognizing a voice signal, comprising a step of generation by an iterative learning procedure of acoustic models representing a standard set of models of vocal units uttered in a given target language and a step of using the acoustic models to recognize the voice signal by comparison of that signal with the acoustic models obtained beforehand, characterized in that during the generation of the acoustic models, there is further generated an additional set of models of vocal units in the target language adapted to the characteristics of a foreign language.

2. A method according to claim 1, characterized in that the additional set of models of vocal units of the target language adapted to the characteristics of a foreign language is estimated from pronunciations of words or phrases in a foreign language.

3. A method according to claim 2, characterized in that a voice signal uttered in a target language and comprising phonemes pronounced in accordance with characteristics of a foreign language is recognized by comparing each utterance with the vocal unit models of the additional set (BR2) and with the vocal unit models of the standard set (BR1).

4. A method according to claim 2, characterized in that a voice signal uttered in a target language and comprising phonemes pronounced in accordance with characteristics of a foreign language is recognized by comparing the signal to be recognized with a combination of vocal unit models of the standard set and vocal unit models of the additional set.

5. A method according to claim 3, characterized in that the acoustic models further comprise a set of models of vocal units uttered in a foreign language.

6. A method according to claim 5, characterized in that a voice signal uttered in a target language and modified in accordance with characteristics of a foreign language is recognized by comparing it with a combination of models of vocal units further comprising a set of models of vocal units uttered in a foreign language.

7. A method according to claim 1, characterized in that a voice signal is compared either to models of vocal units or to combinations of models of vocal units belonging to the standard set or to another set of models of vocal units in a foreign language.

8. A voice recognition system, comprising means for analyzing voice signals (SV_MA) by using an iterative learning procedure to generate acoustic models representing a standard set of models of vocal units (UV_MA) uttered in a given target language, and means for comparing a voice signal to be recognized with the acoustic models of vocal units obtained beforehand, characterized in that the acoustic models further comprise an additional set of models of vocal units in the target language adapted to the characteristics of a foreign language.

9. A method according to claim 4, characterized in that the acoustic models further comprise a set of models of vocal units uttered in a foreign language.

10. A method according to claim 9, characterized in that a voice signal uttered in a target language and modified in accordance with characteristics of a foreign language is recognized by comparing it with a combination of models of vocal units further comprising a set of models of vocal units uttered in a foreign language.
